(19) United States
(12) Patent Application Publication
(10) Pub. No.: US 2007/0124324 A1
(43) Pub. Date: May 31, 2007

(54) Device, method and computer program product for monitoring a group of entities

(75) Inventors: Asaf Adi, Kiryat Ata (IL); Dagan Gilat, Haifa (IL); Royi Ronen, Haifa (IL); Ron David Rothblum, Haifa (IL); Guy Sharon, Rehovot (IL); Inna Skarbovsky, Kiryat Ata (IL)

Correspondence Address: Stephen C. Kaufman;IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY (US)

(21) Appl. No.: 11/290,262

(22) Filed: Nov. 29, 2005

(51) Int. Cl. G06F 7/00

(52) U.S. Cl. 707/102

(57) ABSTRACT

A device, computer readable medium and method for monitoring a group of entities. The method includes: receiving entities information, entity dependency information and entity association information; generating a model of the group of entities that includes multiple abstract dependency instances; evaluating at least one parameter of the group of entities in view of at least one parameter of the model; and dynamically updating the model. A method for dependency resolution, the method includes: defining multiple levels of reactive rules; detecting a certain level situation in response to a lower level event and a previous certain level situation; and providing at least one dependency resolution indication in response to an detection of a high level situation.

### FIELD OF THE INVENTION

The present invention relates to methods, devices and computer program products that monitor a group of entities.

### BACKGROUND OF THE INVENTION

Various monitoring systems and methods were developed in order to monitor a state of modern enterprises. The following U.S. patents and patent applications, all being incorporated herein by reference provide a brief illustration of some prior art monitoring systems and methods: U.S. Pat. No. 6,006,016 of Faigon et al., U.S. Pat. No. 6,604,093 of Etzion et al., patent applications publication serial numbers 2004/0049565 and 2004/0046785 of Keller et al., and U.S. Pat. No. 6847970 of Keller at el.

Modern enterprises can dynamically change. For example a IT infrastructure of an enterprise can be changed by adding or deleting web servers, data bases and the like.

There is a growing need to provide efficient devices, methods and computer readable medium for monitoring dynamically changing group of entities.

### SUMMARY OF THE PRESENT INVENTION

A device, computer readable medium and method for monitoring a group of entities. The method includes: receiving entities information, entity dependency information and entity association information; generating a model of the group of entities that includes multiple abstract dependency instances; evaluating at least one parameter of the group of entities in view of at least one parameter of the model; and dynamically updating the model.

Conveniently, the stage of generating includes defining contexts for each abstract dependency and generating instances of an abstract dependency in response to at least one context of the abstract dependency.

Conveniently, the model includes multiple source entities and wherein the stage of updating includes altering a characteristic of an existing entity.

Conveniently, wherein the stage of generating a model of the group of entities includes generating a model that includes tangible entities and non-tangible entities.

Conveniently, the model includes multiple dependencies and wherein the stage of generating the model including initiating multiple dependency lifecycles.

Conveniently, the state of updating includes applying reactive rules to determine at least one updated parameter of the model.

A device, computer readable medium and method for dependency resolution. The method includes: defining multiple levels of reactive rules; detecting a certain level situation in response to a lower level event and a previous certain level situation; and providing at least one dependency resolution indication in response to an detection of a high level situation.

### BRIEF DESCRIPTION OF THE DRAWINGS

The present invention will be understood and appreciated more fully from the following detailed description taken in conjunction with the drawings in which:

FIG. 1 illustrates a method for monitoring a group of entities, according to an embodiment of the invention;

FIG. 2 illustrates multiple entities, according to an embodiment of the invention;

FIG. 3 is a graph that illustrates associated entities, according to an embodiment of the invention;

FIG. 4 illustrates a method for generating and updating a dependency, according to an embodiment of the invention;

FIG. 5 illustrates a website;

FIG. 6 illustrates a dependency resolution component according to an embodiment of the invention;

FIG. 7 illustrates a website;

FIG. 8 illustrates an exemplary relationship between a source level reactive rule and a memory level reactive rule, according to an embodiment of the invention;

FIG. 9 is a Petri net of various reactive rules, according to an embodiment of the invention;

FIG. 10 illustrates a method for dependency resolution, according to an embodiment of the invention; and

FIG. 11 illustrates a device according to an embodiment of the invention.

### DETAILED DESCRIPTION OF THE DRAWINGS

The invention provides methods, devices and computer readable mediums that are capable of monitoring a group of entities. The group of entities can form an enterprise, a business infrastructure, and the like. The entities can include tangible entities as well as intangible entities. The number of entities can be very large but this is not necessarily so.

According to an embodiment of the invention, the monitoring includes building a model of group of entities by using abstract dependencies and optionally also using non-abstract dependencies. These abstract dependencies act as templates and facilitate automatic dependency instantiations from the abstract dependencies.

Conveniently, the abstract dependencies exempt a user from repeatedly sending definitions of the same structure. Conveniently, many dependencies with a similar structure can be instantiated using a single abstract dependency. Conveniently, entities that participate in the same instance are associated to each other.

According to an embodiment of the invention the model is built by the following stages: receiving entities information, entity dependency information and entity association information, generating a model of the group of entities that includes multiple abstract dependency instances, evaluating at least one parameter of the group of entities in view of at least one parameter of the model, and dynamically updating the model

Conveniently, the model is generated by defining contexts for each abstract dependency, and using the contexts to generate instances of the abstract dependency. It is noted that the contexts can also be used to update the model. It is further noted that the model can also be generated by using non-abstract dependencies.

Conveniently, each abstract dependency has a unique context. The context can include one or more rules that describe the relationship between entity types and especially between attributes that of these entity types.

According to another embodiment of the invention the monitoring includes altering existing dependencies, as well as supporting a deletion or addition of new dependencies.

According to yet a further embodiment of the invention the monitoring includes utilizing a multiple stage dependency lifecycle. Conveniently, the dependency lifecycle includes at least two of the following stages: initialization stage, acquisition stage, resolve stage and end stage.

Conveniently, using the dependency lifecycle does not require redeployment, and is suitable for supporting model evolution without code, query, or schema generation.

According to an embodiment of the invention the resolve stage can be executed during runtime. It conveniently allows to update the model in a fast and an efficient manner.

According to an embodiment of the invention the model is monitored by utilizing a multi-layered mechanism. Conveniently the mechanism includes a source level a memory level and a dependency level.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The method, device and computer readable medium can be used to describe multiple entities of various types, as well as multiple types of dependencies between the multiple entities. Dependencies are used to model connections between components in management and monitoring systems. A dependency expresses how a value of a data element (the dependency target) is affected by other elements (the dependency sources).

For illustrative purposes a value dependency, a business-logic dependency, a translation dependency and a probability based temporal casual dependency are illustrated below.

An Internet access provider allocates bandwidth to customers in response to a current overall load on the system and a level of service assigned to each of the customers. This dependency is a value dependency, as it defines how the allocation values (dependency targets) are determined by other values.

Yet another example, an enterprise internet site can function properly if both its database server and its network server are working. A value representing the enterprise internet site performance level is responsive to functioning values of these two servers. This dependency is a business-logic dependency. It defines a constraint that has to be met to ensure the proper functioning of the monitored object. A monitoring system uses this logic to change dependent values, such as the level of functioning and the alarm-triggering value.

Yet for another example, a data item, described in inches, should be translated to centimeters. The target item is the multiplication of the source item by 2.54. This is a translation dependency, as it defines how a value is translated between two measurement systems. In other words, the inches data item changes to a data item in centimeters by multiplication. Accordingly, these data items depend on each other through a mathematical function.

A network security system reports to the administrator about the likelihood that a Denial of Service (DoS) attack will occur. If the traffic exceeds a certain threshold, a “yellow” state is pronounced; if it exceeds a higher threshold, a “red” state is pronounced. On Monday mornings, the thresholds are 20% higher to reflect that the network is naturally more stressed at that time. This dependency is a probability-based temporal causal dependency with a predictive nature. It defines how the level of likelihood of an attack is determined, based on temporal (and other) factors.

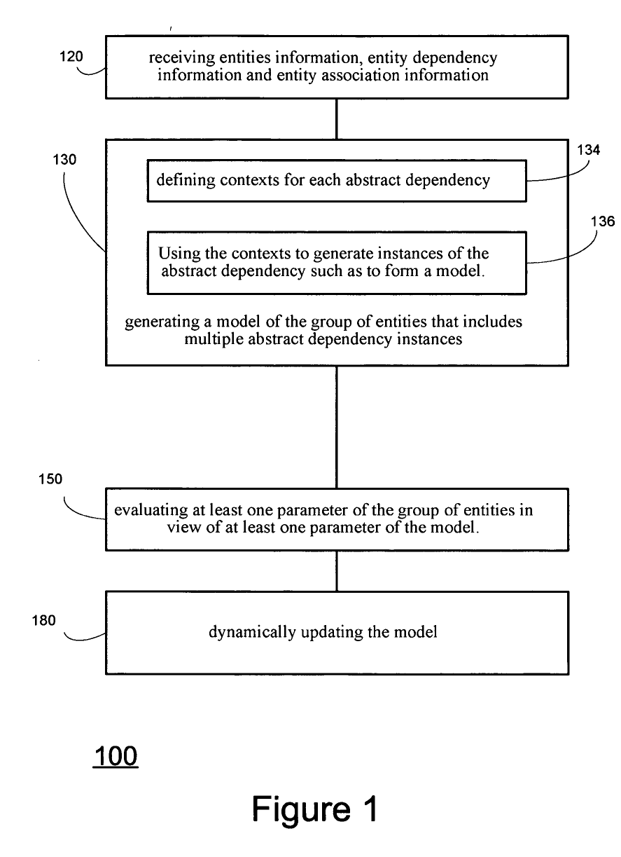

FIG. 1 illustrates method 100 for monitoring a group of entities, according to an embodiment of the invention.

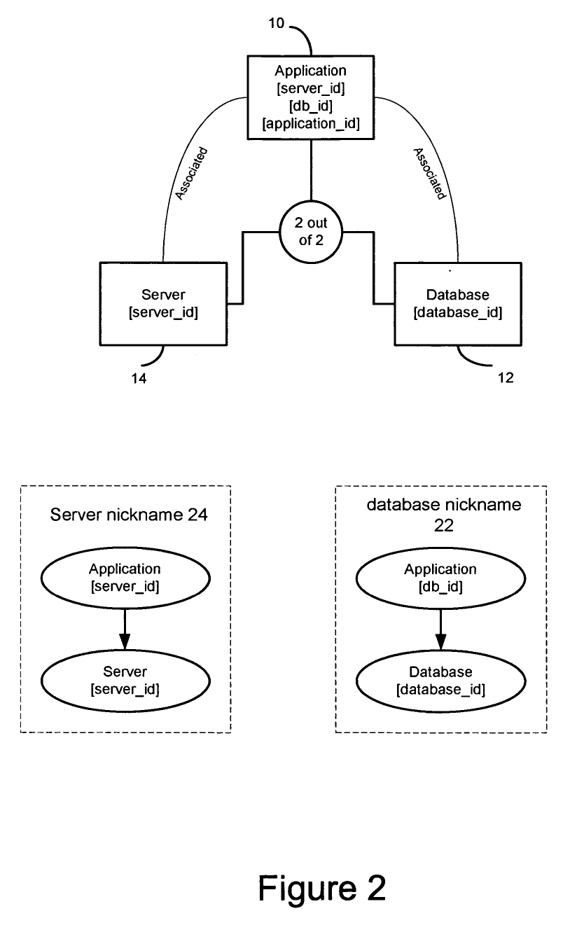

Method 100 starts by stage 120 of receiving entities information, entity dependency information and entity association information. The entity information can include the type of the entities and the attributes of each entity type. The entity dependency information defines dependencies between entity types. The entity association information defines which entity types are associated. Referring to the example set forth in FIG. 2, the entity information represents the existence of three entity types—application 10, database 12 and server 14. It also indicates that application 10 has attributes server_id, db_id and application_id, that database 12 has an attribute database_id and that the server 14 has an attribute server_id.

The entity dependency information indicates that application 10 can function only if database 12 and server 14 are functioning. The entity association information indicates that application 10 is associated with server 14 through their service_id attributes) and that application 10 is associated with database 12 (through db_id and database_id attributes respectively).

Stage 120 is followed by stage 130 of generating a model of the group of entities that includes multiple abstract dependency instances. Stage 130 can include stages 134 and 136.

Stage 134 includes defining contexts for each abstract dependency. These contexts define which entities are associated to each other in a particular abstract dependency.

Conveniently, stage 134 includes generating a graph G(V,E) of components using the received information. V is the set of vertices, each representing an attribute of an entity type in the model. E is the set of edges, each connecting two vertices that represent attributes associated in the model.

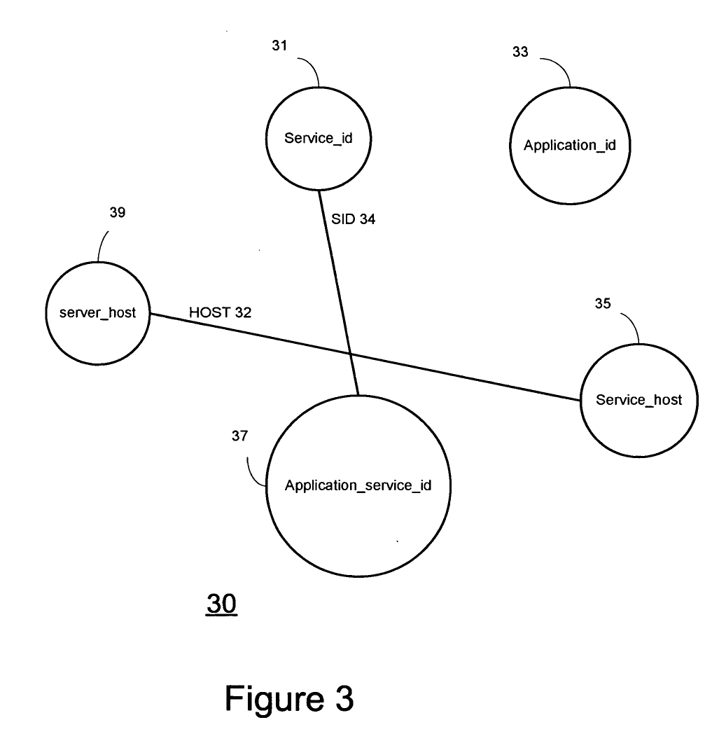

FIG. 3 illustrates a graph 30 that includes attributes service_id 31, application_id 33, service_host 35, application_service_id 37 and server_host 39.

Attributes service_id 31 and application_service_id 37 are linked to each other. Attributes service_host 35 and server_host 39 are also linked to each other.

A service type entity has attributes service_id 31 and service_host 35. A server type entity has a server_host 39 attribute. An application type entity has attributes application_id 33 and application_service_id 37.

The graph 30 indicates that the service type entity is associated with the server type entity through attributes service_host 35 and server_host 39 (represented by nickname HOST), and that the service type entity and the application type entity are associated through attributes service_id 31 and application_service_id 37 (represented by nickname SID).

Stage 134 includes identifying strongly connected components (SCC) in the graph. Each SCC is called a context segment, and can be given a unique name-nickname. A context is a non-empty set of context segments. Graph 30 includes two links that can be describes by two nicknames HOST 32 and SID 34. A set of nicknames that includes these two nicknames is a context.

Graph 30 is used by the procedure instantiating actual dependencies from abstract dependencies.

Referring back to the example set forth in FIG. 2 stage 120 includes defining a database nickname 22 and a server nickname 24. These two nicknames (22 and 24) form a context.

The database nickname 22 indicates that an application type entity and a database type entity are associated to each other (belong to the same instantiation of an abstract dependency) if the value of the db_id attribute of the application type entity and the value of the database_id attribute of the database type entity match.

The server nickname 24 indicates that an application type entity and a server type entity are associated to each other (belong to the same instantiation of an abstract dependency) if the value of the server_id attribute of the application type entity and the value of the server_id attribute of the server type entity match.

Stage 136 includes using the contexts to generate instances of the abstract dependency such as to form a model.

An instantiation of an abstract dependency requires that all the participating entities are connected by associations. Each target entity should be associated through at least one association to at least one source entity, using either directly defined associations or associations implied by transitivity. This requirement can be checked on the graph.

The generation of abstract dependency instances includes defining, in view of the received information, context instances. Entities correspond to a context instance (or to an abstract dependency instance) if attributes that are mapped to the context's nicknames have the same values as in the context instance.

The following exemplary code builds a context of a given abstract dependency d, and the subsets of the context that correspond to each source.

CtxtSubSets = φ

for each target element (t) in d

for each source (s) element in d

for each attribute (as) type in s

at = s.as.getAssociation(t)

if at is not null

nn = new nickname
t.Nicks = t.Nicks ∪ {<nn,

| | |
|---|---|
| t.at>} | s.Nicks = |

s.Nicks ∪ {<nn, s.as>}
endif

endfor

endfor

endfor

endfor

for each source element (s) in d
CtxtSubSets = CtxtSubSets ∪ s.Map
endfor

This exemplary algorithm goes over the targets. If one of the sources’ attributes is associated with the target, a new nickname is added to the target-nicks set and to the source-nicks set. After passing over all the targets, all the nick sets of all the targets should be identical, and each of them is in fact the complete list of nicknames, i.e., the dependency context. In addition, the CtxtSubSets contains the relevant nicknames for each source separately, and is used at runtime to determine if source elements should participate in a dependency.

Stage 130 is followed by stage 150 of evaluating at least one parameter of the group of entities in view of at least one parameter of the model. This stage can include determining the state of a certain group of entities in response to the state of various entities that belong to the group and one or more rules that describe how the state of one or more entities can affect the state of other entities of the group. Various examples of such evaluations are further provided in the following figures.

Stage 150 is followed by stage 180 of dynamically updating the model. The update can include receiving events or indications of events. These events can represent an addition of entities, a deletion of entities, a change of an existing entity and the like. These events trigger a dynamic alteration of the model.

It is noted that after an update or even during model updates the method can evaluate at least one parameter of the group of entities.

Conveniently stage 180 can include multiple dependency generating and updating stages, such as various stages of method 200.

Stage 180 may include adding a new entity to the model. When a new entity is added, it is checked against all relevant abstract dependencies for a match.

If an entity type of the added entity participates as a target in an abstract dependency and if it is the only target in its context, then a new dependency instance is initiated.

If there is an existing dependency in the same context, then the added entity is added to that dependency.

If the dependency to be instantiated is part of a compound dependency (a composition of more than one dependency where the result of one dependency is the source of another), then all the dependencies which take part in the compound dependency, are initiated.

Once the dependency is created, existing source entities of the same context should be added to it. The addition can be required as a dependency is only created when the first target entity exists. Thus, various source entities can exist before the addition of that first target.

If the added entity is a source of an abstract dependency instance then it is connected to a dependency of the same context if one exists. If not, it is stored for prospective instantiation of the abstract dependency.

Stage 180 can include removing an entity. If the removed entity functions only as the source of one or more dependencies, it is simply removed from the dependency. This may alter the structure or the outcome of that dependency.

If the entity is a target to a dependency, it is removed from the dependency with no further consequences. However, when the entity is the only target left, then the dependency is ended.

Stage 180 can include changing an existing entity. The values of entities may change due to effects or changes in the resolution of another dependency that is a source to the entity. The change can be reflected in the value of one or more attributes of that entity. This change can cause changes in the participation of entities in dependencies in either joining or disjoining an already existing dependency. If the changed entity is the source of a dependency and due to the change should no longer be one, the entity disjoins the dependency.

If an entity was not a source and due to the change should now be one, it joins the dependency. Such changes necessitate the resolution of the dependency with respect to its new structure, and propagate the change through the model.

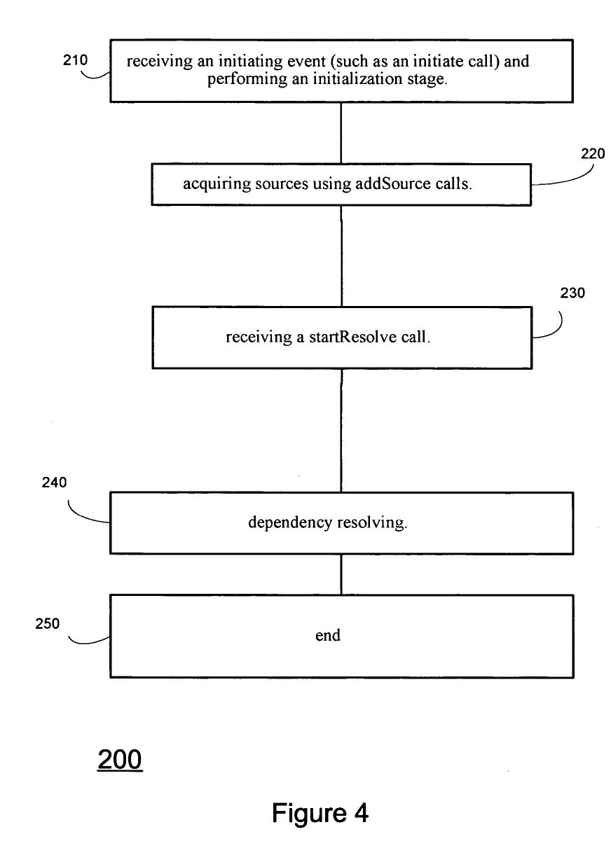

FIG. 4 illustrates method 200 for generating and updating a dependency, according to an embodiment of the invention.

This dependency can be generated and updated during a dependency lifecycle. A model can include multiple dependencies and each dependency has its own lifecycle.

Some of the lifecycles overlap, some partially overlap and some dependencies lifecycles do not overlap. A dependency can be added, removed or altered and it can affect other dependencies in the model.

The stages of method 200 are triggered by various events. For convenience of explanations these events are represented by a set of exemplary commands. Those of skill in the art will appreciate that other commands as well as other events can trigger the various stages of method 200.

Method 200 starts by stage 210 of receiving an initiating event (such as an initiate call) and performing an initialization stage 210. The dependency is initiated through the initiate call (also referred to as start call). Initial parameter values (for parameterized semantics) are received through this call.

Stage 210 is followed by stage 220 of acquiring sources using addSource calls.

Stage 220 is followed by stage 230 of receiving a startResolve call.

Stage 230 is followed by stage 240 of dependency resolving. During this stage, new sources can be added through addSource calls, existing sources can be removed through removeSource calls or updated through changeSource calls. Dependency parameters can be updated too, through the updateParameter call. These changes can affect the resolution of the dependency, triggering the execution of report calls for every change.

Stage 240 is followed by end stage 250. A dependency is terminated by an end call.

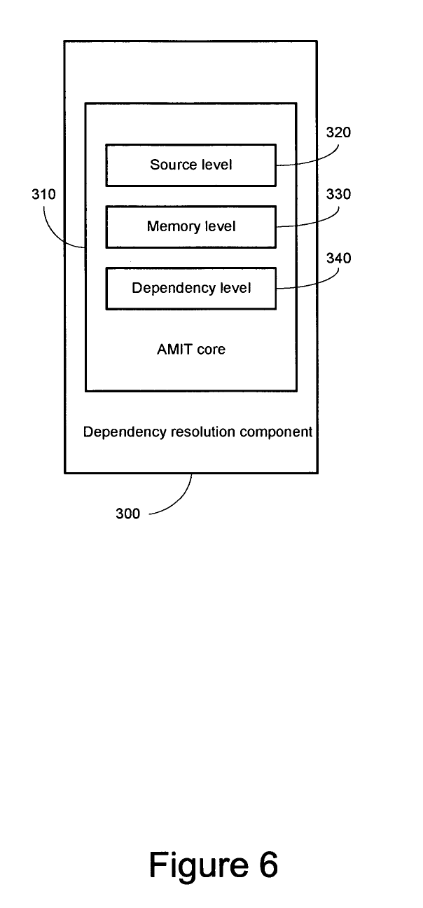

Conveniently, stage 240 is executed by a dependency resolution component. A dependency resolution component can include an AMIT core, as further illustrated in FIG. 6, but this is not necessarily so. The dependency resolution component can implement the dependency lifecycle calls and dependency semantics. It can provide dependency resolution services through a report call. Conveniently, it is the only component in the system that relates to the semantics of dependency types.

AMIT core can be included within an off the shelf situation awareness unit that is sold under the name AMIT by International Business Machines of Armonk, N.Y., U.S.A. U.S. patent application publication serial number 2005/0096966, which is incorporated herein by reference, provides a brief description of the AMIL core.

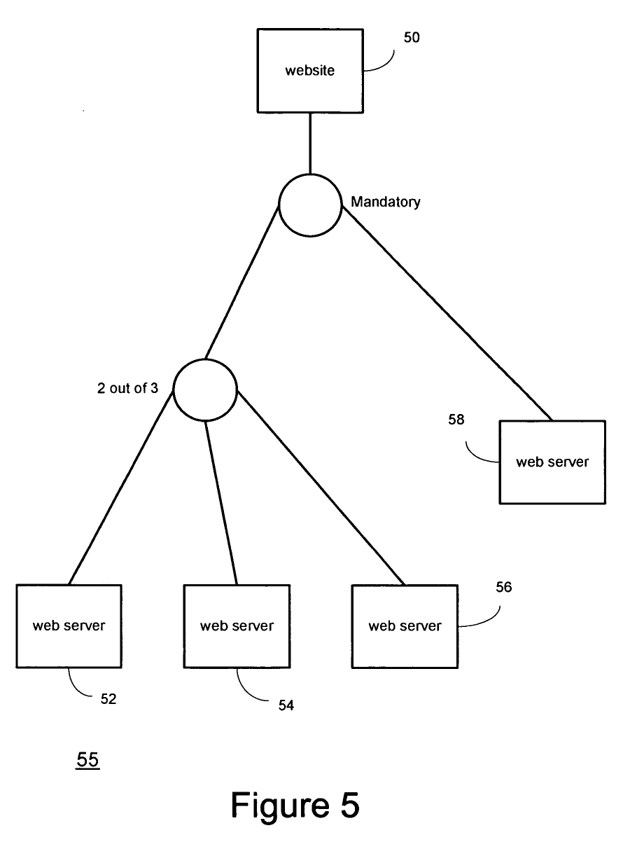

Method 200 is further illustrated in reference to the example set forth in FIG. 5. FIG. 5 illustrates a website 50 that can operate if two out of three web servers 52, 54 and 56 are functional and if server database 58 is functional. These entities are all associated to each other—they are in the same context.

It is assumed that during stage 210 web servers 52 and 54 are created. No dependency is created yet, since the entities function only as sources. The sources are stored for possible participation in a possible prospective instantiation of the abstract dependencies in which they participate.

During stage 220 website 50 is created (added). Since it is a target to a dependency (mandatory) and it is the first one, the dependency is initiated. In this case the dependency is itself the target of another dependency (two-out-of), forming a compound dependency, so the two-out-of dependency is created as well. After this stage the model includes entities website 50 , web servers 52 and 54 , and a compound dependency that partially depends upon these entities.

After this stage a dependency resolution stage (such as stage 240 ) can start. It is assumed that web server 56 and server database 58 are added. They, in addition to the previously provided entities, provide dependency 55 of FIG. 5.

If the model includes multiple dependencies like dependency 55 then the automatic instantiation of the abstract dependencies can assist in feeding in the information about these multiple entities as well as resolving source additions, deletion and alterations.

According to an embodiment of the invention either one of methods 100 and 200 can make use of reactive rules in dependency resolution. One or more reactive rules can be used for the calculation of an updated value of a dependant element using the elements it depends on. Conveniently, the set of reactive rules that are used for dependency resolution is generic and stays the same or substantially the same regardless of the topology of the model for which it provides dependency resolution.

Reactive rules can be used in monitoring dynamically changing group of entities where entities can be added or deleted, without having to change any code or rules definition or stop the process of monitoring for monitoring system redeployment.

FIG. 6 illustrates a dependency resolution component 300 according to an embodiment of the invention.

The dependency resolution component 300 includes a AMIT core 310 which is an event driven reactive rule engine.

The dependency resolution component 300 conveniently uses generic rules that are relevant to any model. The rules conveniently imprint the model in them in addition to performing the dependency resolution itself.

According to an embodiment of the invention the dependency resolution component 300 receives events (or information representing an occurrence of an event) representing alterations of existing entities, removal of entities or addition of entities and send these events to the AMIT core 310. The AMIT core 310 processes these events to detect when predefined situations occur.

The AMIT core 310 performs dependency resolution and sends to the dependency resolution component 300 events with resolved values of dependant entities. These resolved values can represent at least one parameter of a monitored group of entities. The resolved values can also be further processed to provide an evaluation of at least one parameter of a monitored group of entities.

Conveniently the AMIT core 310 applies three levels of AMIT rules—source level 320, memory level 330 and dependency level 340.

The source level 320 informs the memory level 330 about changes in the state of sources as well as a removal or addition of sources. The input to the memory level 330 are source situations. The memory level 330 is in charge of a book-keeping task regarding the sources of a single dependency. The memory level 330 can be regarded as a situation. It keeps track on the values of the sources as they get updated. The dependency level 340 derives a resolution result according to the semantics of the dependency. The input to the dependency level 340 are memory situations.

Each level detects the occurrence of situations by applying predefined operations of one or more associated operands. An operand can be an event, a situation and the like. Exemplary operators include “All”, “Sequence” and “At least n” operators but other operators can be used. A situation that is detected by applying an “All” operator on multiple events is detected if all the events occurred. A situation that is detected by applying a “Sequence”operator on multiple events is detected if the events occur in a defined order. A situation that is detected by applying an “At Least n” operator is detected when at least n events occur. Each operator is applied on events that are associated to each other in various degree.

Various events can refer to an addition of a source, a removal of a source and an update of an existing source. One event can trigger another event. For example, a source creation events can trigger a source update event.

Conveniently, once the state of a source is updated or even after a source is created the AMIT core 310 receives a source report event. The reception of the source report event enables a first detection of a source situation. When a source report event occurs it is correlated with an already existing source update event. By applying an “ALL” operand of these events a new source situation is detected.

In the source level 320 events that relates to the same source can affect each other. Memory events that relate to the same dependency can affect each other. Assuming that entities that belong to the same dependency have that same value of a dependency_id attribute and that different entities within the same dependency differ by the value of their place attribute then source events are associated to each other if their dependency_id and place attribute values match while memory events are associated to each other if the value of their dependency_id match.

According to an embodiment of the invention the source level 320 detects source situations by applying “ALL” operands on a previous source situation and a current source update event. This feedback provides information about a previous state of a source.

According to an embodiment of the invention the memory level 320 detects memory situations by applying “ALL” operands on a previous memory situation and current source update situations. This feedback provides information about a previous state of the sources.

Conveniently, a source is removed by generating a ReportSource event with null value for its state attribute. When another source is created at the same dependency, it will replace the removed source. In other words, the source level associated with a specific place in the dependency is not necessarily terminated when the source is removed, but can be reused by the next source in the same place.

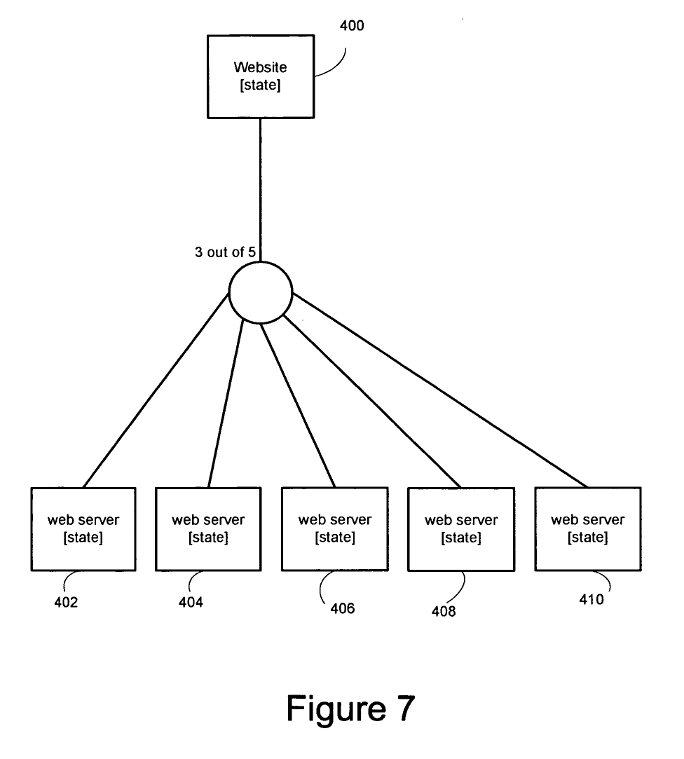

The operation of the dependency resolution component 300 is further illustrated in reference to FIG. 7. An availability of website 400 is monitored. Website 400 is a target entity and has a state attribute that represents the state of website 400. The state of Website 400 is determined by the state of the third best web server out of servers 402-410. This is a “n out of m” dependency, m equals five and n equals three. The state of each of these entities (value of the state attribute) can be: OK, warning, problem and fail. If the states of the web servers 402-410 are {OK, warning, OK, problem, fail} then the state of website 400 will be warning.

Four counters are also defined: OK_counter, warning_counter, problem_counter and fail_counter. The OK_counter counts the number web servers that are OK, the warning_counter counts the number of web servers that their state is warning, the problem_counter counts the number of web servers that their state is problem, and the fail_counter counts the number of web servers that their state is fail. The values of these counters are reflected in the following attributes: number_OK, number_warning, number_problem and number_fail (used in the memory level).

A dependency resolution process should determine the state of website 400 from the states of web servers 402-410.

This process uses the following events and attributes: (i) CreateSource event, including Dependency_id and place attributes, (ii) RemoveSource event, including Dependency_id and place attributes, (iii) ReportSource event, including Dependency_id, place and state attributes, (iv) UpdateSource event, including Dependency_id, place, state and previousState attributes, (v) Noutof start event that includes a Dependency_id and n attributes, and (vi) MemoryEvent event, including Dependency_id, number_OK, number_warning, number_problem and number_fail attributes.

The CreateSource event indicates that a new source was added. The UpdateSource event indicates that a state of a source changed. A Noutof event determines the dependency type (in our case attribute n equals 3, as the state of website 400 is determined according to the state of the third best web server). A RemoveSource indicates that a source was removed. A ReportSource event is used to report a state of a source. When the state of the source changes a ReportSource event that includes the updates state is generated.

The dependency_id attribute represents the dependency (for example the dependency between website 400 and web servers 402-410) that the events relates to. The place attribute represents the source (for example which web server out of 402-410) that the event relates to. The state attribute indicates the state of the source while the previousState attribute represents the previous state of the source.

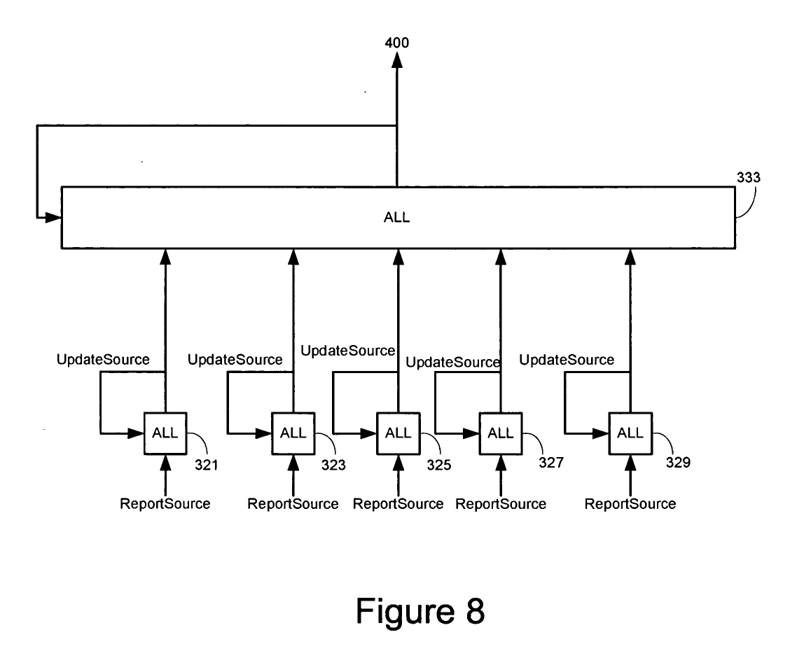

In the source level 320 previous UpdateSource events (also act as an UpdateSource situation update to the memory level 330) are correlated with current associated ReportSource events and this correlation can trigger a new SourceUpdate event. The new UpdateSource situation is detected by applying an “All” operand on the previous UpdateSource event and the current ReportSource event. This correlation is illustrated by the feedback loops of FIG. 8.

The SourceCreate event imprints the addition of the source element to the model by triggering an UpdateSource event. This UpdateSource event is set with attributes state and previous_state as null to reflect the fact that a new entity was added. Since the state of that source is not necessarily known when it is added to the dependency the null value is provided.

A CreateSource event triggers a ReportSource event which indicates the initial state of the new source.

A RemoveSource event triggers a ReportSource event with null value for its state attribute.

When a state of an existing source is changed a ReportSource event is sent to the AMIT core 310. The ReportSource indicates the new state of that source.

FIG. 8 illustrates an exemplary relationship between the source level 320 and the memory level 330. The source level 320 includes five boxes 321-329, each box representing events related to one web server out of web servers 402-410. The events of that source are sorted according to the values of their dependency_id and place attributes.

If, for example entities 400-410 were an instance of an abstract dependency then events that relate to entities that belong to other instances of the abstract dependency will have different dependency_id attribute values.

The memory level 330 includes one box 333 that represents events that relate to all web servers 402-410. In order to receive information representative of a previous state each box (out of boxes 321-333) receives a feedback that indicates the previous state of the box.

The following XML code detects a source situation which is a source update situation:

<situation name=“UpdateSource”>

<all>
<operandAll eventType=“Report Source”/>
<operandAll eventType=“UpdateSource”/>
<keyBy name=“place”/>
<keyBy name=“dependency_id”/>

</all>
<situationAttribute attributeName=“dependency_id”
expression=“key(dependency_id)”/>

<situationAttribute attributeName=“place”

expression=“ReportSource.place”/>

<situationAttribute attributeName=“state”

expression=“ReportSource.state”/>

<situationAttribute attributeName=“previous state”

expression=“UpdateSource.state”/>
</situation>

The UpdateSource situation is detected by applying an “All” operand on events ReportSource and UpdateSource that are keyed by their attributes place and dependency_id.

The memory level box 333 applies an “all” operand on the source level UpdateSource situations and on the previous memory situation. The detection of situations starts by receiving a start event. A memory level event includes multiple attributes, representing the values of the number_OK counter, the number_warning counter, the number_problem and the number_fail counter. These counters can be initialized to zero, until an updating memory situation is detected.

The following XML code detects a memory situation. For convenience of explanation source level operands are referenced by u and memory level operands are referenced by m.

<situation name=“memory”>

<all>

<operandAll eventType=“UpdateSource” as=“u”/>
<operandAll eventType=“memory” as=“m”/>
<keyBy name=“dependency_id”/>

</all>
<situationAttribute attributeName=“dependency_id”

expression=“key(dependency_id)”/>

<situationAttribute attributeName=“Number_OK”

expression=“if (u.state=‘OK’) then (m.Number_OK+1)
elseif (u.previousState=‘OK’) then (m.Number_OK−1)
else m.Number_OK endif”/>

<situationAttribute attributeName=“Number_warning”

expression=“if (u.state=‘warning’)
then (m.Number_warning+1) elseif
(u.previousState=‘warning’)
then (m.Number_warning−1)
else m.Number_warning endif”/>

<situationAttribute attributeName=“Number_problem”

expression=“if (u.state=‘problem’)
then (m.Number_problem+1) elseif
(u.previuosState=‘problem’)
then (m.Number_problem−1)
else m.Number_problem endif”/>

<situationAttribute attributeName=“Number_fail”

| | | |
|---|---|---|
| expression=“if | (u.state=‘fail’) | then |

(m.Number_fail+1)

elseif (u.previousState=‘fail’) then (m.Number_fail−

1)

else m.Number_fail endif”/>

</situation>

The dependency level is in charge of deriving the final result according to the semantics of the dependency. It uses the memory situation as an input and provides a dependency resolution result. Referring to the example set forth in FIG. 7 the result is the state of website 400—the state of the third best web server.

The following XML code provides a result that applies the best 3 out of m rule:

<situation name=“Noutof”>

<all detectionMode=“immediate”>

<operandAll eventType=“Noutof Start” as=“s”/

retain=“true”/>

<operandAll eventType=“memory” as=“m”>
<keyBy name=“dependency_id”/>

</all>
<situationAttribute attributeName=“dependency_id”

expression=“m.dependency_id)”/>

<situationAttribute attributeName=“STATE”

expression=“if ((m.Number_ok−s.n)>=0)

then ‘state_ok’
elseif (((m.Number_ok+m.Number_warning)−s.n)>=0)
then ‘state_warning’
elseif

(((m.Number_ok+m.Number_warning+m.Number_problem)−s.n)>=0)

then ‘state_problem’ else ‘state_fail’
endif”/>

</situation>

The situation attribute expression performs the check to find in which state the nth best source is, with respect to the n provided by the start event. A start event is sent to the AMIT core 310 once when the dependency is created.

Referring to the examples set forth in FIG. 7 and FIG. 8, various exemplary scenarios are illustrated.

It is assumed that when the dependency was started the values of all counter attributes are zero and that a dependency rule of best 3 out of m is also set. It is also assumed that the dependency includes website 400 and four web servers 402-408.

Given this initial state the AMIT core 310 receives a source addition event that adds web server 410. This event will have a dependency_id attribute value that corresponds to that dependency but a place attribute value that differ from the values of place attributes of events that created web servers 402-408.

The source addition event triggers a source update situation with null values for its state and previous_state attributes. This source update situation is correlated with a referenced memory situation to produce a new memory situation. The counters attributes of the memory event remain the same until the state of the new source is also provided.

The AMIT core 310 then receives a source report event that is detected by box 329 that corresponds to web server 410. It is assumed that the source report event changes the state of web server 410 from null (unknown) to OK.

The update situation will have OK in the state attribute, and null in the previous_state attribute. The memory situation uses this event as an operand, but this time, Number_OK attribute of the memory situation will be affected. It will be incremented by one, in order to reflect that a new source was added to the dependency in state OK.

Now it is assumed that another source report event occurs, changing the state of a single source from OK to problem. The source level produces an update situation with the values problem and OK in the state and previous_state attributes respectively. This update situation is correlated with the latest memory situation and a new memory situation is detected. This source report event affects two memory event attributes—Number_OK and Number_problem. Number_OK attribute is decremented by one while number_Problem attribute is incremented by one.

At the dependency level the values of the counters (attributed of the memory situation) are monitors and the state of the third best web server is provided as the state of the website 400.

The previous examples explained a “n-out-of” dependency level rule. It is noted that other rules can be applied, causing changes in the dependency level. For example, if the website 400 state is the state of the worst web server (mandatory dependency) then the dependency level will look for the first non-zero counter, starting from the number_fail counter, number_problem counter, number_warning counter and number_OK counter.

It is noted that the AMIT core 310 can also apply dependency rules that are not state related. For example, a sum dependency can be implemented by using events that include value attributes, the memory level adds new values to previous values, and the dependency level is empty. Product dependency type, with the semantics of multiplying the sources values, functions almost the same. The difference is that in product, the memory level divides the total by the previous value, and multiplies by the current. Sources are created with the multiplicity-neutral value, namely one. To remove sources, their current value is set to one.

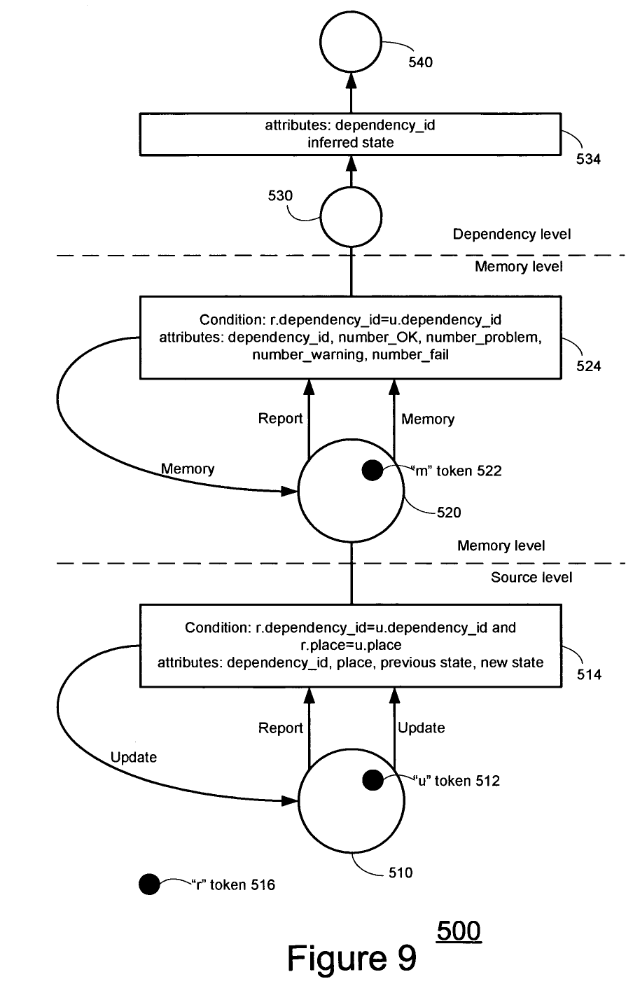

FIG. 9 is a Petri net 500 of various reactive rules, according to an embodiment of the invention

Petri net is a graphical tool that includes tokens, places, transitions and arcs that connect places and transitions. The tokens can be distinguished from each other by their type. The tokens can be included within places.

A transition can fire if all the conditions to the activity are fulfilled. For convenience of explanations Petri Net 500 include boxes (514, 524 and 534) that include the conditions of each corresponding transitions. These boxes also indicate the value of attributes that are generated when a transition occurs.

Petri net 500 also include a source level place 510, a memory level place 520, a dependency level place 530 and an additional place 540.

A detection of a situation is illustrated by a transition that fires. When a transition fires it removes tokens from its input places and adds some at all of its output places.

A report source event is represented by token “r” 516. A source update event is represented by token “u” 512. A memory event is represented by token “m” 522.

The source level transition (an arc that exits box 514 and enters circle 520 ) occurs if token “r” 516 and an associated token “u” 512 are provided, as illustrated by the arcs that exit circle 510 and enter box 514. When the transition fires two “u” tokens are generated. These “u” tokens can have updated attributes. One of these “u” tokens is returned to source level place 510 and the other is sent to the memory level place 520. The returned u token can be correlated with a new r token.

The “u” token that is sent to the memory level place 520 is correlated (As can seen by box 524) with an already existing associated m token. The first “m” token was placed in the memory level place 520 in order to represent the reference of the first memory event by start. For the memory level transition to fire, associated “m” token and “u” token are required. The produced tokens are two “m” tokens. One is put back to the memory level place 520, and the other is provided to the dependency level place 530. The attribute of these two “m” tokens are set according to the content of box 524.

A dependency level transition (box 534) provides the state of the dependency.

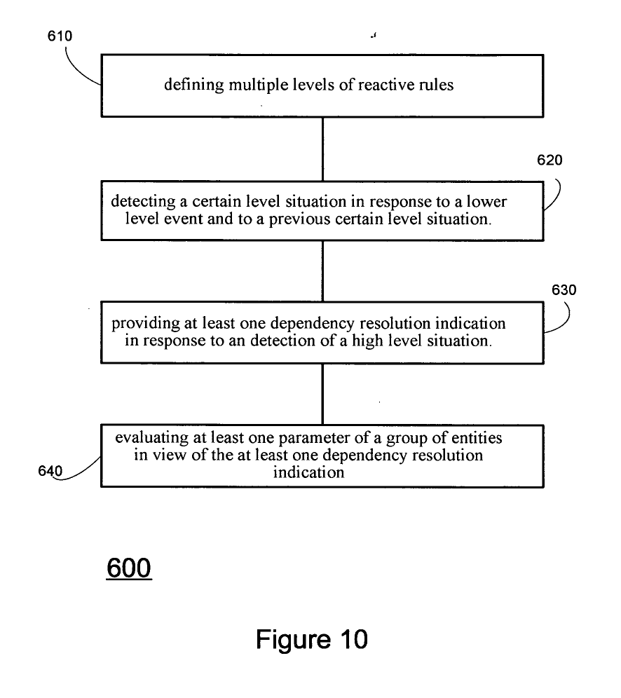

FIG. 10 illustrates method 600 for dependency resolution, according to an embodiment of the invention.

Method 600 starts by stage 610 of defining multiple levels of reactive rules. Referring to the example illustrated in the previous figures these levels can include source level rules, memory level rules and dependency level rules.

Stage 610 is followed by stage 620 detecting a certain level situation in response to a lower level event and to a previous certain level situation. Referring to the example set forth in the previous figures a source situation is detected in response to a previous source situation and a current source report event. An analogues feedback is also applied in the memory level.

Stage 620 is followed by stage 630 of providing at least one dependency resolution indication in response to a detection of a high level situation. Referring to the example set forth in previous figures the indication can reflect the state of website 400.

Conveniently method 600 can use different association rules in different levels of reactive rules. For example, source level events are associated if their dependency_id attribute values and their place attribute values are the same while memory events are associated if their dependency_id attribute values are the same.

Stage 630 can be followed by stage 640 of evaluating at least one parameter of a group of entities in view of the at least one dependency resolution indication.

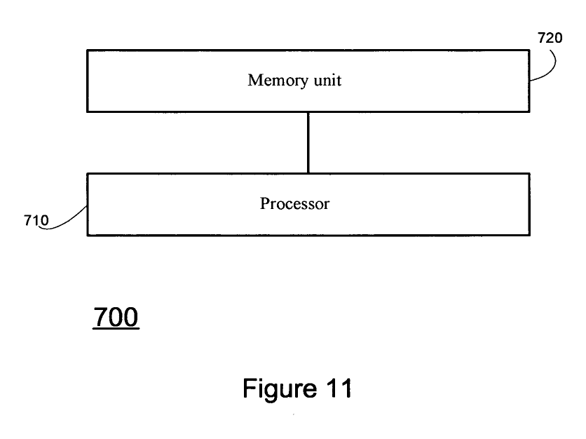

FIG. 11 illustrates a device 700 according to an embodiment of the invention.

Device 700 can include various components such as a processor, a GUI, an event unit a memory unit, an input port, an output port a database engine, an active dependency integration unit, an awareness situation unit, and integration unit and a situation evaluation unit, as further illustrated in U.S. patent application publication serial number 2005/0096966 titled “Method and system for active monitoring of dependency models”, which is incorporated herein by reference. This is not necessarily so.

Device 700 can receive events via various ports, network adaptors, and the like. It conveniently includes a processor 710 that is connected to a memory unit 720.

Memory unit 720 is adapted to store entities information, entity dependency information and entity association information. Processor 710 can retrieve the stored information and generate a model of the group of entities that includes multiple abstract dependency instances, evaluate at least one parameter of the group of entities in view of at least one parameter of the model, and dynamically update the model.

Conveniently, the processor 710 is adapted to define multiple levels of reactive rules; detect a certain level situation in response to a lower level event and a previous certain level situation; and provide at least one dependency resolution indication in response to a detection of a high level situation.

It is noted that device 700 can apply either one of methods 100, 200 and 600.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the following claims.

We claim

1. A method for monitoring a group of entities, the method comprising:
receiving entities information, entity dependency information and entity association information;
generating a model of the group of entities that comprises multiple abstract dependency instances;
evaluating at least one parameter of the group of entities in view of at least one parameter of the model; and
dynamically updating the model.

2. The method according to claim 1 whereas the stage of generating comprises defining contexts for each abstract dependency and generating instances of an abstract dependency in response to at least one context of the abstract dependency.

3. The method according to claim 1 wherein the model comprises multiple source entities and wherein the stage of updating comprises altering a characteristic of an existing entity.

4. The method according to claim 1 wherein the stage of generating a model of the group of entities comprises generating a model that comprises tangible entities and non-tangible entities.

5. The method according to claim 1 wherein the model comprises multiple dependencies and wherein the stage of generating the model comprising initiating multiple dependency lifecycles.

6. The method according to claim 1 wherein the state of updating comprises applying reactive rules to determine at least one updated parameter of the model.

7. A method for dependency resolution, the method comprises:
defining multiple levels of reactive rules; detecting a certain level situation in response to a lower level event and a previous certain level situation; and
providing at least one dependency resolution indication in response to an detection of a high level situation.

8. The method according to claim 7 further comprising applying a first association rule at one level and applying another association rule at another level.

9. The method according to claim 7 further comprising evaluating at least one parameter of a group of entities in view of the at least one dependency resolution indication.

10. A computer program product comprising a computer useable medium including a computer readable program, wherein the computer readable program when executed on a computer causes the computer to:
receive entities information, entity dependency information and entity association information;
generate a model of the group of entities that comprises multiple abstract dependency instances;
evaluate at least one parameter of the group of entities in view of at least one parameter of the model; and
dynamically update the model.

11. The computer program product of claim 10 wherein the computer readable program when executed on a computer further causes the computer to define at least one context for each abstract dependency and to generate instances of an abstract dependency in response to at least one context of the abstract dependency.

12. The computer program product of claim 10 wherein the model comprises multiple source entities and wherein the computer readable program when executed on a computer further causes the computer to alter a characteristic of an existing entity.

13. The computer program product of claim 10 wherein the model comprises multiple dependencies and wherein the computer readable program when executed on a computer further causes the computer to initiate multiple dependency lifecycles.

14. The computer program product of claim 10 wherein the computer readable program when executed on a computer further causes the computer to apply reactive rules to determine at least one updated parameter of the model.

15. The computer program product of claim 10 wherein the computer readable program when executed on a computer further causes the computer to define multiple levels of reactive rules; detect a certain level situation in response to a lower level event and a previous certain level situation; and provide at least one dependency resolution indication in response to an detection of a high level situation.

16. The computer program product of claim 15 wherein the computer readable program when executed on a computer further causes the computer to apply a first association rule at one level and apply another association rule at another level.

17. A device comprising a processor and a memory unit coupled to the processor, wherein the memory unit is adapted to store entities information, entity dependency information and entity association information; wherein the processor is adapted to generate a model of the group of entities that comprises multiple abstract dependency instances; evaluate at least one parameter of the group of entities in view of at least one parameter of the model; and dynamically update the model.

18. The device according to claim 17 wherein the processor is further adapted to define multiple levels of reactive rules; detect a certain level situation in response to a lower level event and a previous certain level situation; and provide at least one dependency resolution indication in response to an detection of a high level situation.

19. The device according to claim 17 wherein the processor is adapted to apply reactive rules to determine at least one updated parameter of the model.

20. The device according to claim 17 wherein the processor is adapted to generate a model of a group of entities that comprises tangible entities and non-tangible entities.
